(19) United States
(12) Patent Application Publication
(10) Pub. No.: US 2008/0223843 A1
(43) Pub. Date: Sep. 18, 2008

(54) SLIDE-OUT HEATER MODULE FOR VOLTAGE ELECTRICAL EQUIPMENT

(76) Inventor: Richard G. White, Lake Orion, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/047,889

(22) Filed: Mar. 13, 2008

Related U.S. Application Data
(60) Provisional application No. 60/894,715, filed on Mar. 14, 2007.

(51) Int. Cl. H05B 3/00

(52) U.S. Cl. 219/209

(57) ABSTRACT

A slide out heater module for use with a voltage electrical equipment for reducing internal moisture and including an elongated bracket upon which is supported a strip heater in slidably displaceable fashion. The module includes a stationary component secured inside the electrical equipment, with a moveable component being slidably displaced between installed and removed positions. A convective heating strip is supported upon the moveable component. In this fashion, the module can be withdrawn and the heating replaced during normal maintenance without interrupting the power within the enclosure.

### CROSS-REFERENCE TO RELATED APPLICATIONS

The present application claims the priority of U.S. Provisional Patent Application Ser. No. 60/894,715, filed Mar. 14, 2007, and entitled SLIDE OUT HEATER MODULE FOR USE WITH MEDIUM VOLTAGE ELECTRICAL EQUIPMENT.

### FIELD OF THE INVENTION

The present invention relates to a moisture/condensation reducing heater module in use with such as exterior located and medium voltage switches, in particular associated with medium and low voltage electrical equipment. More particularly, the heater module is intended as an improvement over prior art strip heaters which are powered by existing (e.g. 120V to 480V) power, such as from within the building or structure serviced by the equipment. As will be further disclosed, a substantially “U” shaped bracket supports the strip heater thereupon and is slidable along a track such that male and female pin connectors are cooperatively engaged for selectively powering the heater upon the module being fully installed within the assembly. In this fashion, the module can be withdrawn and the heater replaced during normal maintenance without interrupting the power within the enclosure.

### BACKGROUND OF THE INVENTION

Most types of medium voltage electrical equipment, such as outdoor metering cubicals and primary switches rated at 5,000 to 60,000 voltas and high voltage equipment rated at 60,000 to 24,000 volts are ordered with small strip type electrical heaters. As is known in the art, these heaters are typically installed by the manufacturer during the production of the electrical equipment and are typically located in the lower portion of the equipment. These heaters further receive their power from a 120 volt to 480 volt source within the building, or structure serviced by the equipment or by a transformer within the medium or high voltage equipment.

The heaters' function is to provide a low level heat source inside the electrical equipment which creates convection, thus reducing or eliminating any moisture that may occur. By eliminating moisture, the risk of condensation is eliminated and, accordingly, so is the risk of any shorting, arcing or corrosion occurring inside the equipment.

When properly functioning, these heaters provide a very efficient mechanism for the removal of moisture typically occurring in such outdoor locations. As is known however, any type of electric heating element will fail over a period of time. That period of time is determined by how long the heater is in constant use. Typically these heaters are wired to operate 24 hours a day, 7 days a week and 365 days a year.

When a heater fails or burns out, it usually remains in that condition for an extended period of time, typically for two reasons. The first reason is that the customer usually has no way of knowing when the heater has failed. The second is that, given the heater is mounted inside the medium voltage equipment, the inability to detect a non-operational heater module is usually compounded.

Manufacturers are required to install interlocking devices on the doors of this equipment to prevent access while the equipment is energized. Servicing these heaters requires the electrical equipment to be de-energized, and before the equipment door can be opened. This can cause anywhere from a minor to major disruption to the customer because electrical power to their buildings will be off during this time.

Referencing the prior patent art relating to this technology. Wilke, I I, U.S. Pat. No. 6,072,159, teaches a draw-out heater service module and switchgear incorporated into a bus bar compartment of a switchgear cabinet and insertable through a rear to be supported by an internally configured and U shaped bracket.

Berger, U.S. Pat. No. 6,043,464, teaches an environmental control apparatus for controlling the humidity and temperature in a closed environment such as outdoor electrical switchgear boxes. Of note, Berger teaches the inclusion of both temperature and humidity sensors incorporated into a controller and which compares the sensed conditions to low temperatures and a high humidity setpoint. If either the temperature fails below a setpoint or the humidity exceeds a further setpoint, a heater is energized.

Among the other references uncovered, the EP 0002660 reference, to Heppner, teaches another type of heating device for use with a switch box. This reference is only disclosed in German, however reference to the drawings and the translated Abstract indicates that it teaches a substantially “U” shaped baseplate upon which is supported the heat conducting/radiating material and which is also provided with a thermostatic control.

Other references of note include Japanese Abstracts (see publications Nos. 10215506 and 01253188) relating to other applications of heating elements incorporated into a distribution panel. Another U.S. reference of note is the electrical heating device disclosed in Hofer, U.S. Pat. No. 4,352,008, and which teaches magnetic support of an extruded and heat radiating body within the panel enclosure.

The Lutz U.S. Pat. No. 6,615,521, teaches an outdoor electrical display sign incorporating an electrical resistance heating element exhibited on a transparent front panel for removing condensation or for dissipating precipitation from the front of the sign. The resistance element can be adhesively secured, in either inward or outward facing fashion, onto a surface of the transparent front panel, taped onto a surface of the panel, laminated, photo-screened, photo-etched, or formed by pouring an electrical resistance material into minute grooves formed in the front panel.

### SUMMARY OF THE INVENTION

The present invention is a slide-out service module which is incorporated into voltage existing electrical equipment. The module exhibits two main components, a stationary component and a movable component which is contains an associated strip heater. A plurality of bolts or screw fasteners secures the stationary portion of the module to the main body of the equipment. Upon removing the fasteners, a service individual can safely slide the movable portion of the heater module out of the electrical equipment without the need for otherwise de-energizing (shutting off the power to) the equipment. Once removed from the electrical equipment, a heater component incorporated into the movable portion can be replaced.

The stationary and movable portions of the module make contact with such as a 120V power source by such as pin and sleeve connectors. In one application, the female connector can be incorporated into a stop plate, in turn incorporated into the stationary portion of the heater module. The male connector in turn is incorporated into the movable portion of the module and such that, upon sliding the movable portion into contact with the stationary portion, the male and female connectors make contact to restore power to the heater module.

Additional features include the outer edges of the removable module being cantilevered to form a squared, inverted “U” shape, or other desired cross sectional configuration. Likewise, the stationary portion or “track” that the moveable module will slide upon can be cantilevered and incorporated into a frame of the electrical equipment.

Additional features associated with the heater module include it incorporating a fuse and two indicator lights. The first indicator light illuminates to show that the power supplying the module is on. The second indicator light likewise illuminates to show that current is flowing through the heating element. Proper functioning of the heating element is evidenced by current flow which is sensed by a current sensor and shown by an illuminated LED or other suitable light. Upon the heating element failing, the current sensor will in that condition not sense a current flow and the LED will cease to be illuminated. The fuse and indicator lights are preferably mounted on the outside plate of the movable service unit.

Additional variants include the design of the slide out heater module incorporated into either the initial electrical equipment manufacturing process or retrofit installed into an already existing piece of equipment, and such as part of a retrofit installation kit. Although not shown, additional variants contemplate the slide-out heater module fitted with both de-humidistat and thermostat controls. The use of such controls reduces energy costs and prolongs the life of the heat strip. The slide-out heater can also be installed in low voltage electrical assemblies (e.g. rated 600 Volts or below) when such assemblies are either installed outside or in an environment in which high humidity or extreme temperature fluctuations exist.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is perspective view illustration of a three dimensional and voltage source cabinet exhibiting a front panel face and incorporating the heater module according to a preferred embodiment of the present inventions;

FIG. 2 is an assembled side view of the heater module in the installed position of FIG. 1 and with the stationary and movable components in communicating position;

FIG. 3 is an enlarged front plan view of the slide out heater module; and

FIG. 4 is a three dimensional exploded perspective of the stationary and movable components associated with the slide out heater subassembly.

### DETAILED DESCRIPTION OF THE PREFERRED EMBODIMENTS

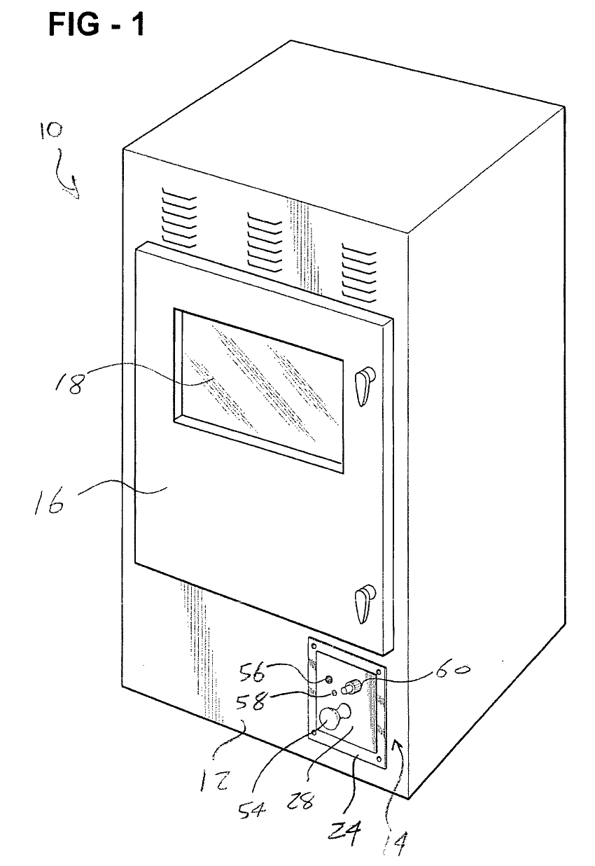

Referring to FIG. 1, a perspective view is shown at 10 of a three dimensional and voltage source cabinet and including a front panel face 12 and incorporating a heater module, see as further generally referenced at 14, according to a preferred embodiment of the present inventions. As is conventionally known, the panel may provide access to a known type of low or medium voltage electrical equipment (primary switchgear). A panel door 16 may further include (optionally) a viewing window 18 for visual access to its interior components, and without having to first open the panel door.

As previously described, the present invention relates to a moisture/condensation reducing heater module in use with such as exterior located low and medium voltage switches. More particularly, the heater module is intended as an improvement over prior art strip heaters which are powered by existing (e.g. 120V) power, such as from within the building or structure serviced by the equipment. As will be further disclosed, a substantially “U” shaped bracket supports the strip heater thereupon and is slidable along a track such that male and female pin connectors are cooperatively engaged for selectively powering the heater upon the module being fully installed within the assembly. In this fashion, the module can be withdrawn and the heater replaced during normal maintenance without interrupting the power to the structure.

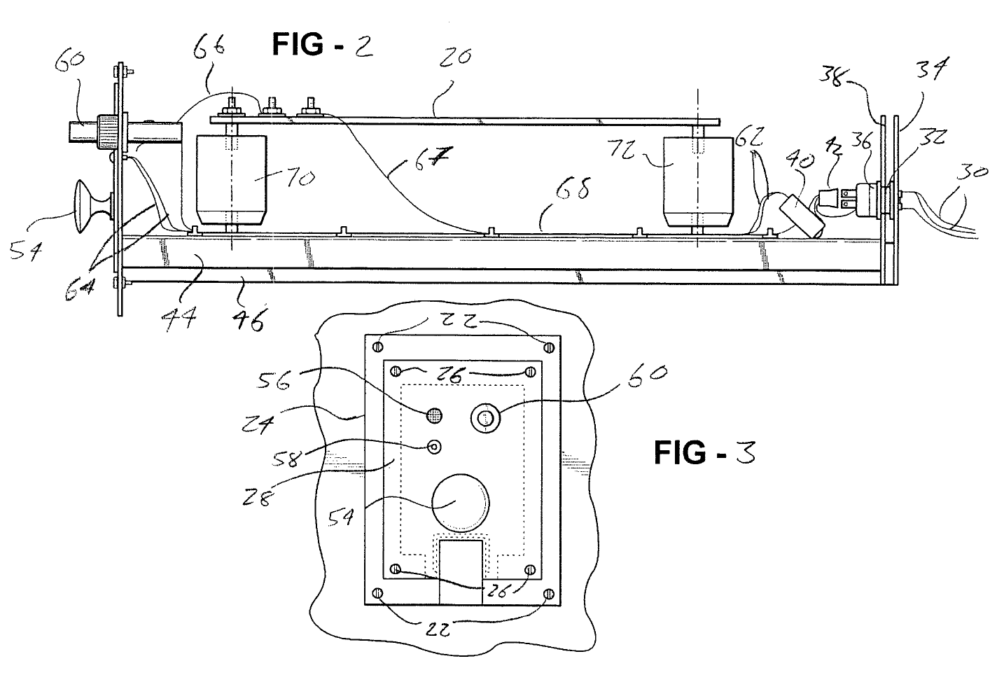

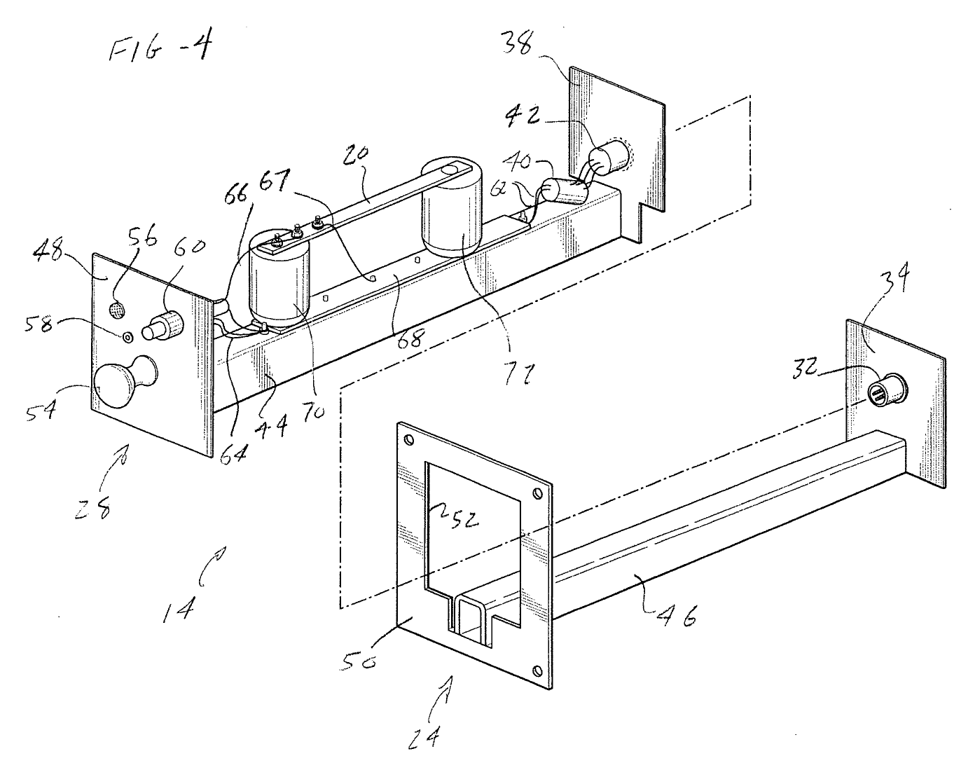

Referencing again FIG. 1, along with the remaining illustrations of FIGS. 2-4, the convection heater module 14 exhibits a generally lengthwise extending, thin strip (convective) heater 20 (see in particular FIGS. 2 and 5). A plurality of fasteners, including such as screws or bolts, are shown at 22 in FIG. 3 for securing an outer/stationary component 24 (see also FIG. 4) to the cabinet panel face 12 of the electrical equipment. A second plurality of fasteners 26 are further provided for securing an inner movable component 28 (again FIG. 4) to the outer/stationary component 24.

In use, and upon removal of the second plurality of screws 26, a user servicing the heater can safely slide the movable heater component 28 outwardly from the outer stationary component 24 mounted within the electrical equipment panel, and without the need for de-energizing the equipment, such as further during repair or removal and replacement of the heater element 30. The stationary and movable portions of the module make contact with such as a 120V power source (see as referenced by wires 30 in FIG. 2) by such as pin and sleeve connectors.

In one application, a female connector 32 can be incorporated into a rearward located stop plate 34, in turn incorporated into the stationary component 24 of the heater module. A male connector 36 is in turn is incorporated into the movable portion (see opposing rearward most plate 38) of the module and such that, upon sliding the movable component 28 into contact with the stationary component 24, the male 36 and female 32 connectors make contact to restore power to the heater module and which is further referenced by a current indicator sensing relay 40 including a cup shaped contact 42 engageable over the male connector 36.

Additional features include elongated and downward outer edges of the removable component 28 being cantilevered to form a squared, inverted “U” shape 44, or other desired cross sectional configuration. Likewise, a similarly configured stationary portion or “track” 46 associated with the stationary component 24 also exhibits a slightly smaller dimensioned and track supporting or mating configuration (such as again a “U” shape) and such that the moveable/slidable component 28 can be translated to selectively engage or disengage the male and female connectors.

Referring specifically to FIG. 4, the movable component 28 also includes a front face plate 48 separated from the rear plate 38 by the inverted “U” track 44. The stationary component 24 further exhibits a front face plate 50 exhibiting an inner window opening (see edge 52) through which is communicated the rear plate 38 of the movable component 28 during installation of the movable component 28 over the stationary component 24.

Additional features associated with the slide out heater module include it incorporating a fuse and two indicator lights. These are evident from the exterior facing surface of the front plate 48 and, in addition to a pull handle 54 include a first indicator light 56 illuminating to show that the power supplying the module is on. A second indicator light 58 likewise illuminates to show that current is flowing through the heating element.

Further referenced at 60 is a panel mount indicating fuse holder and which is communicated with the current indicator sensing relay 40 by wires 62 and 64 (FIG. 4). Additional wires 66 and 67 communicate heater element 20 to the fuse holder 60 as well as to a base plate 68 upon which is supported a pair of insulators 70 and 72 for upwardly spacing and supporting the convective heater element 20.

Proper functioning of the heating element 20 is evidenced by current flow which is sensed by a current sensor (see again current indicator sensing relay 40 in FIGS. 2 and 4) and shown by the illuminated LED 58 or other suitable light. Upon an occurrence of the heating element 20 failing, the current sensor will in that condition not sense a current flow and the LED 58 will cease to be illuminated. As again shown, the fuse 60 and indicator lights 56 and 58 are preferably mounted on the outside plate 48 of the movable service component 28, in proximity to the pull handle 54, however it is also envisioned that other configurations can be employed within the scope of the present invention.

Beyond the embodiment described herein, additional variants include the design of the slide out heater module incorporated into either the initial electrical equipment manufacturing process or retrofit installed into an already existing piece of equipment, and such as part of a retrofit installation kit. Although not shown, additional variants contemplate the slide-out heater module fitted with both de-humidistat and thermostat controls. The use of such controls reduces energy costs and prolongs the life of the heat strip. The slide-out heater can also be installed in low voltage electrical assemblies (e.g. rated 600 Volts or below) when such assemblies are either installed outside or in an environment in which high humidity or extreme temperature fluctuations exist.

Although not illustrated, the slide-out heater module can be fitted with both de-humidistat and thermostat controls, if so desired. The use of these controls will help reduce energy costs and prolong the life of the heat strip. Additional applications include the slide-out heater being installed in low voltage electrical assemblies (600 volts and below), and when such assemblies are either installed outside or in an environment that has high humidity or extreme temperature fluctuations. Yet additional features illustrated in FIG. 2 include the provision of a gripping handle to facilitate removal and reinsertion of the heater module.

Additional features includes adapting the operational parameters associated with the fuse and indicator light (such as rated at 125% of the wattage of the heater element) such that it is capable of notifying/illuminating prior to actual heating element failure (this possible by determining the instance of an increase in current, and which is indicative of an impending failure condition). Yet additional features include the optional provision of a humidistat, wired in series with the heater on the load side of the fuse, and capable of intermittently actuating the heater (rather than maintaining it in the on condition at all times) in response to a detected humidity level inside the electrical equipment enclosure exceeding a preset limit. The advantages of selectively actuating the strip heater include both power savings and increasing its effective life.

Having described my invention, other and additional preferred embodiments will become apparent to those skilled in the art to which it pertains, and without deviating from the scope of the appended claims.

I claim:

1. A slide out heater module in use with voltage electrical equipment, comprising:
a stationary component adapted to being secured to an interior enclosure location associated with the electrical equipment; and
a movable component upon which is supported a convective strip heater and which is slidably engaged with said stationary component between a first installed position in which current flow is enabled to the strip heater and a second removed position in which current flow is interrupted and said movable component capable of being slidingly disengaged from the electrical equipment panel without requiring de-energizing of the equipment.

2. The heater module as described in claim 1, further comprising a first connector incorporated into a rearward location of said stationary component, a second connector incorporated into said movable portion such that, upon sliding said movable component into contact with said stationary component, said first and second connectors contact to restore power to said strip heater.

3. The heater module as described in claim 2, further comprising a female connector incorporated into a rearward located stop plate associated with said stationary component, a male connector in turn is incorporated into a rear plate associated with said movable component.

4. The heater module as described in claim 3, further comprising a current indicator sensing relay including a cup shaped contact engageable over said male connector.

5. The heater module as described in claim 4, further comprising a first elongated and inverted cross sectional track associated with said movable component, a second similarly configured and stationary track associated with said stationary component dimensioned such that said moveable component can be translated to selectively engage or disengage said female and male connectors.

6. The heater module as described 5, said movable component further comprising a front face plate separated from said rear plate by said inverted track, said stationary component further comprising a front face plate exhibiting an inner window opening through which is communicated said rear plate of said movable component during installation of said movable component with said stationary component.

7. The heater module as described in claim 6, further comprising a panel mount indicating fuse holder and a pair of indicator lights secured to exterior facing surface of said front face plate of said movable component in addition to a pull handle.

8. The heater module as described in claim 7, a first of said indicator lights illuminating to show that a power supply associated with said heater module is active.

9. The heater module as described in claim 8, a second of said indicator lights illuminating to show that current is flowing through said strip heater.

10. The heater module as described in claim 9, further comprising said panel mount indicating fuse holder communicating with said current indicator sensing relay via a first plurality of wires.

11. The heater module as described in claim 10, further comprising a second plurality of wires communicating said heater element to said fuse holder, as well as to a base plate upon which is supported a pair of insulators for upwardly spacing and supporting said convective strip heater.

12. The heater module as described in claim 7, further comprising a humidistat, wired in series with said heater module on a load side of said fuse holder, and capable of intermittently actuating said heater in response to a detected humidity level inside the electrical equipment enclosure exceeding a preset limit.

13. A slide out heater module in use with voltage electrical equipment, comprising:
a stationary component adapted to being secured to an interior enclosure location associated with the electrical equipment, a female connector incorporated into a rearward located stop plate associated with said stationary component;
a movable component upon which is supported a convective strip heater, a male connector in turn is incorporated into a rear plate associated with said movable component and such that said movable component is slidably engaged with said stationary component between a first installed position in which current flow is enabled to the strip heater and a second removed position in which current flow is interrupted and said movable component capable of being slidingly disengaged from the electrical equipment panel.

14. The heater module as described in claim 13, further comprising a current indicator sensing relay including a cup shaped contact engageable over said male connector.

15. The heater module as described in claim 14, further comprising a first elongated and inverted cross sectional track associated with said movable component, a second similarly configured and stationary track associated with said stationary component dimensioned such that said moveable component can be translated to selectively engage or disengage said female and male connectors.

16. The heater module as described 15, said movable component further comprising a front face plate separated from said rear plate by said inverted track, said stationary component further comprising a front face plate exhibiting an inner window opening through which is communicated said rear plate of said movable component during installation of said movable component with said stationary component.

17. The heater module as described in claim 16, further comprising a panel mount indicating fuse holder and a pair of indicator lights secured to exterior facing surface of said front face plate of said movable component in addition to a pull handle.

18. The heater module as described in claim 17, a first of said indicator lights illuminating to show that a power supply associated with said heater module is active.

19. The heater module as described in claim 18, a second of said indicator lights illuminating to show that current is flowing through said strip heater.

20. A slide out heater module in use with an item of voltage created electrical equipment, said heater module comprising:
a stationary component adapted to being secured to an interior enclosure location associated with the electrical equipment;
a movable component upon which is supported a convective strip heater and which is slidably engaged with said stationary component between a first installed position in which current flow is enabled to the strip heater and a second removed position in which current flow is interrupted and said movable component capable of being slidingly disengaged from the electrical equipment panel without requiring de-energizing of the equipment; and
a panel mount indicating fuse holder and a pair of indicator lights secured to exterior facing surface of a front face plate associated with said movable component, a first of said indicator lights illuminating to show that a power supply associated with said heater module is active, a second of said indicator lights illuminating to show that current is flowing through said strip heater.
